(19) United States
(12) Patent Application Publication
(10) Pub. No.: US 2018/0335518 A1
(43) Pub. Date: Nov. 22, 2018

(54) APPARATUS AND METHODS FOR QUAD-POLARIZED SYNTHETIC APERTURE RADAR

(71) Applicant: URTHECAST CORP., Vancouver (CA)

(72) Inventor: Peter Allen Fox, Burnaby (CA)

(21) Appl. No.: 15/502,468

(22) PCT Filed: Aug. 5, 2015
(86) PCT No.: PCT/US2015/043739

§ 371 Date: Feb. 7, 2017

Related U.S. Application Data
(60) Provisional application No. 62/035,279, filed on Aug. 8, 2014.

(51) Int. Cl. G01S 13/90; G01S 7/02; G01S 7/40

(52) U.S. Cl. CPC G01S 13/9035; G01S 7/025; G01S 2013/9076; G01S 7/4021; G01S 7/40; G01S 7/026

(57) ABSTRACT

A quad-pol synthetic aperture radar (SAR) system reduces the effects of range ambiguities in a quad-pol SAR data. Pulses are transmitted in two sub-bands at respective ones of two different linear orientations. For each sub-band and orientation, returns are received in two orientations, and filtered to attenuate the other sub-band. A scattering matrix may be determined from the results. Additionally or alternatively, a Faraday rotation angle associated with acquired quad-pol SAR data is estimated, and used to correct a scattering matrix. Estimation may occur before, after, or both before and after acquisition of the quad-pol SAR data.

### BACKGROUND

### Technical Field

The present application relates generally to synthetic aperture radar (SAR) and, more particularly, to quad-polarization (quad-pol) imaging radar systems for determining the polarization scattering matrix and classifying areas and targets in radar images.

### Description of the Related Art

A limitation of conventional quad-pol SAR imaging at lower frequencies (L-Band, for example) with smaller antennas are increased levels of the range ambiguities. Quad-pol SAR demands a doubling of the Pulse Repetition Frequency (PRF) to ensure adequate sampling of the azimuth spectrum. Doubling the PRF brings the range ambiguities closer in elevation to the main beam of the antenna, and increases their magnitude.

Consequently, a smaller antenna results in increased range ambiguities which, if not reduced in some manner, can result in increased signal-dependent noise in the image, degrading both the quality of the image and the accuracy of the scattering matrix. Classification of areas and targets in the resulting quad-pol images, and recovery of geophysical parameters based on the scattering matrix can likewise be negatively affected by increased range ambiguities.

In addition, accurate determination of the scattering matrix can also be degraded by Faraday rotation, which occurs when radar waves at lower frequencies (L-Band, for example) propagate through the ionosphere. The effects of Faraday rotation on the scattering matrix can cause an erroneous correlation of the cross-polarization and co-polarization terms. The erroneous correlation can result in a non-symmetrical scattering matrix, contrary to the expected result based on the scattering reciprocity principle. The non-symmetrical scattering matrix can result in misclassification of areas and targets in the quad-pol SAR image.

### BRIEF SUMMARY

The technology described herein addresses the aforementioned issues associated with range ambiguities and Faraday rotation, and comprises apparatus and methods for generating high-quality SAR images with accurate determination of the polarization scattering matrix using smaller antennas than conventionally achievable. Benefits of smaller antennas include reductions in overall SAR mass, volume and cost.

The technology comprises a first aspect in which a sub-band quad-pol SAR imaging mode is used in conjunction with a smaller antenna (<5 m², for example) than would otherwise be employed to determine the scattering matrix with lower levels of range ambiguities and for wider imaging swaths than can be achieved by conventional approaches using the same-size antenna.

The technology comprises a second aspect which is an apparatus and method for co-spatial and co-temporal determination of the Faraday rotation of electromagnetic waves propagating in the ionosphere, and for correction of quad-pol SAR data for the effects of Faraday rotation.

The first and second aspects of the technology can be applied separately or in combination. For example, the sub-band imaging mode can be applied when Faraday rotation does not need to be corrected, such as at C-Band frequencies. Similarly, co-spatial and co-temporal determination of the Faraday rotation can be applied to lower frequency SAR (L-Band, for example) with conventionally large antennas.

Both methods can be applied in combination to achieve beneficial results, in particular at lower frequencies (L-Band) and with unconventionally small antennas (<5 m²).

An advantage of the technology described here is that more accurate measurement of the scattering matrix and classification of areas and targets in quad-pol SAR images can be performed at lower frequency bands (L-Band, for example) and with smaller antennas than with conventional SAR systems and methods.

A method of operation in a quad-pol synthetic aperture radar (SAR) system to reduce effects of range ambiguities in quad-pol SAR data may be summarized as including: for each of a number of iterations i, from 1 to a number N where N is an integer greater than zero, transmitting a first pulse with a first linear polarization in a first sub-band of a bandwidth; receiving a first return from the first pulse in the first linear polarization; providing the received first return in the first linear polarization to at least one filter as a first channel; receiving the first return from the first pulse in a second linear polarization, the second linear polarization orthogonal to the first linear polarization; providing the received first return in the second linear polarization to at least one filter as a second channel; transmitting a second pulse with the second linear polarization in a second sub-band of the bandwidth; receiving a second return from the second pulse in the first linear polarization; providing the received second return in the first linear polarization to at least one filter as a third channel; receiving the second return in the second linear polarization; and providing the received second return in the second linear polarization to at least one filter as a fourth channel.

The method may further include: filtering the first and the second channels to attenuate frequencies in the second sub-band; and filtering the third and the fourth channels to attenuate frequencies in the first sub-band. Transmitting a first pulse with a first linear polarization in a first sub-band of a bandwidth may include transmitting the first pulse with one of a horizontal polarization or a vertical polarization. Transmitting a second pulse with the second linear polarization in a second sub-band of a bandwidth may include transmitting a second pulse with the second linear polarization in a second sub-band that does not overlap the first sub-band. Transmitting a first pulse with a first linear polarization in a first sub-band of a bandwidth may include transmitting the first pulse via a first antenna feed, and transmitting a second pulse with the second linear polarization in a second sub-band of the bandwidth may include transmitting the second pulse via a second antenna feed. The method may further include: operating at least one switch to successively cause an antenna to transmit the first pulse via the first antenna feed with the first linear polarization in the first sub-band and the antenna element to transmit the second pulse via the second antenna feed with the second linear polarization in the second sub-band. The method may further include: operating at least one switch to successively couple a transmitter to the first antenna feed to transmit the first pulse with the first linear polarization in the first sub-band and to the second antenna feed to transmit the second pulse with the second linear polarization in the second sub-band. The method may further include: generating a scattering matrix from the filtered output of the first, the second, the third and the fourth channels. The method may further include: determining a calibration amplitude and phase that, when applied to the filtered output, makes cross-polarization terms in the scattering matrix substantially the same as each other or at least reduces the difference between cross-polarization terms in the scattering matrix; and applying the calibration amplitude and phase to correct at least one value in the filtered output of at least one of the first, the second, the third or the fourth channels. The method may further include: determining a calibration amplitude and phase that, when applied to the filtered output, makes cross-polarization terms in the scattering matrix the same as each other; and applying the calibration amplitude and phase to correct at least one value in the filtered output of at least one of the first, the second, the third or the fourth channels. The method may further include: transmitting a third pulse with one of either the first or the second linear polarizations in a third sub-band of the bandwidth; receiving a third return from the third pulse in one of the first or the second linear polarizations; and providing the received third return to at least one filter as a further channel. N may be greater than 1.

A quad-pol synthetic aperture radar (SAR) system, may be summarized as including: a dual linearly-polarized antenna comprising two orthogonal linear feeds; at least one transmitter operatively connected to the antenna, wherein a bandwidth of the at least one transmitter comprises a first sub-band and a second sub-band; a controller operatively coupled to the at least one transmitter and which in use causes the at least one transmitter to transmit a plurality of pulses, the plurality of pulses alternatingly having a first linear polarization in the first sub-band, and a second linear polarization in the second sub-band, wherein the second linear polarization is orthogonal to the first linear polarization; and a receiver communicatively coupled to the antenna to receive two orthogonal linear polarizations of a set of radar returns from each of the plurality of pulses, and to provide received radar returns to at least one filter as a first, a second, a third and a fourth channel.

The quad-pol SAR system may further include: a signal processor comprising: a first filter communicatively coupled to the receiver and which in use attenuates frequencies of the received radar returns in the second sub-band; a second filter communicatively coupled to the receiver and which in use attenuates frequencies of the received radar returns in the first sub-band; and a processor communicatively coupled to receive an output of the first and the second filters, and which in use generates a scattering matrix. The first filter may filter the first and the second channels to attenuate frequencies in the second sub-band and the second filter may filter the third and the fourth channels to attenuate frequencies in the first sub-band. The signal processor may be co-located with the at least one transmitter, the controller, and the receiver on-board a spacecraft. The second sub-band may not overlap the first sub-band. The quad-pol SAR system may further include: at least one switch which in use successively causes the dual linearly-polarized antenna to alternatingly transmit the pulses with the first linear polarization in the first sub-band and to transmit pulses with the second linear polarization in the second sub-band. The at least one switch may successively couple the at least one transmitter alternatingly to a first one of the two orthogonal feeds and then to a second one of the two orthogonal feeds.

A method of operation in a quad-pol synthetic aperture radar (SAR) imaging system which includes at least one processor and at least one processor-readable medium that stores at least one of processor-executable instructions or data may be summarized as including: acquiring a set of quad-pol SAR data representative of a target; estimating a Faraday rotation angle associated with the acquired set of quad-pol SAR data; and correcting a scattering matrix of the target based on the estimated Faraday rotation angle, wherein the estimating of the Faraday rotation angle is performed co-spatially and co-temporally with the acquisition of the set of quad-pol SAR data.

Estimating of the Faraday rotation angle may include: transmitting a plurality of right-hand circular polarization (RHCP) pulses; receiving left-hand circular polarization (LHCP) backscatter from the plurality of RHCP pulses; forming a first image from the plurality of transmitted RHCP pulses and the received LHCP backscatter; transmitting a plurality of LHCP pulses interleaved with the plurality of RHCP pulses; receiving RHCP backscatter from the plurality of LHCP pulses; forming a second image from the plurality of transmitted LHCP pulses and the received RHCP backscatter; and determining a phase difference between the first image and the second image, wherein the phase difference is the estimate of the Faraday rotation angle. Estimating of the Faraday rotation angle may be performed before acquiring the set of quad-pol SAR data. Estimating the Faraday rotation angle may be performed after acquiring the set of quad-pol SAR data. Estimating the Faraday rotation angle may be performed at a first time before acquiring the set of quad-pol SAR data to provide a first estimate of the Faraday rotation angle, and performed at a second time after acquiring the set of quad-pol SAR data to provide a second estimate of the Faraday rotation angle, the method further including averaging the first estimate and the second estimate to determine the Faraday rotation angle. Acquiring may occur on-board a spacecraft. Acquiring a set of quad-pol SAR data representative of a target may include: for each of a number of iterations i, from 1 to a number N where N is an integer greater than zero, transmitting a first pulse with a first linear polarization in a first sub-band of a bandwidth; receiving a first return from the first pulse in the first linear polarization; providing the received first return in the first linear polarization to at least one filter as a first channel; receiving the first return from the first pulse in a second linear polarization, the second linear polarization orthogonal to the first linear polarization; providing the received first return in the second linear polarization to at least one filter as a second channel; transmitting a second pulse with the second linear polarization in a second sub-band of the bandwidth; receiving a second return from the second pulse in the first linear polarization; providing the received second return in the first linear polarization to at least one filter as a third channel; receiving the second return in the second linear polarization; and providing the received second return in the second linear polarization to at least one filter as a fourth channel. Acquiring a set of quad-pol SAR data representative of a target may further include: generating a scattering matrix from the filtered output of the first, the second, the third and the fourth channels. Acquiring a set of quad-pol SAR data representative of a target may further include: determining a calibration amplitude and phase that makes cross-pol terms in the scattering matrix the same as each other; and applying the calibration amplitude and phase correct at least one value in the filtered output of at least one of the first, the second, the third or the fourth channels.

A system for use with a quad-pol synthetic aperture radar (SAR) may be summarized as including: at least one processor; and at least one processor-readable medium that stores at least one of processor-executable instructions or data, wherein in use the at least one processor: acquires a set of quad-pol SAR data representative of a target; estimates a Faraday rotation angle associated with the acquired set of quad-pol SAR data co-spatially and co-temporally with the acquisition of the set of quad-pol SAR data; and corrects a scattering matrix of the target based on the estimated Faraday rotation angle.

To estimate the Faraday rotation angle, the at least one processor may: form a first image from a plurality of transmitted right-hand circular polarization (RHCP) pulses and received left-hand circular polarization LHCP backscatter; form a second image from a plurality of transmitted LHCP pulses and received RHCP backscatter; and determine a phase difference between the first image and the second image, wherein the phase difference is the estimate of the Faraday rotation angle. The at least one processor may further: cause at least one transmitter to transmit a plurality of RHCP pulses; receive the LHCP backscatter from the plurality of RHCP pulses via a receiver; cause the at least one transmitter to transmit a plurality of LHCP pulses interleaved with the plurality of RHCP pulses; and receive the RHCP backscatter from the plurality of LHCP pulses via the receiver. The at least one processor may estimate the Faraday rotation angle before the set of quad-pol SAR data is acquired. The at least one processor may estimate the Faraday rotation angle after the set of quad-pol SAR data is acquired. The at least one processor may estimate the Faraday rotation angle at a first time before the set of quad-pol SAR data is acquired to provide a first estimate of the Faraday rotation angle, and the at least one processor may estimate the Faraday rotation angle at a second time after the set of quad-pol SAR data is acquired to provide a second estimate of the Faraday rotation angle, and the at least one processor may further average the first estimate and the second estimate to determine the Faraday rotation angle. The at least one processor may be located on-board a spacecraft. To acquire the set of quad-pol SAR data representative of a target, the at least one processor may further: cause a transmission of a first pulse with a first linear polarization in a first sub-band of a bandwidth; receive a filtered first return to the first pulse in the first linear polarization with frequencies of a second sub-band attenuated; receive a filtered first return to the first pulse in the second linear polarization with frequencies of the second sub-band attenuated; cause a transmission of a second pulse with the second linear polarization in the second sub-band of the bandwidth; receive a filtered second return to the second pulse in the first linear polarization with frequencies of the first sub-band attenuated; and receive a filtered second return to the second pulse in the second linear polarization with frequencies of the first sub-band attenuated. To acquire a set of quad-pol SAR data representative of a target the at least one processor may further: generate a scattering matrix from the filtered output. To acquire a set of quad-pol SAR data representative of a target the at least one processor may further: determine a calibration amplitude and phase that, when applied to the filtered output, makes cross-pol terms in the scattering matrix substantially the same as each other or at least reduces the difference between cross-polarization terms in the scattering matrix; and apply the calibration amplitude and phase correct at least one value in the filtered output. To acquire a set of quad-pol SAR data representative of a target the at least one processor may further: determine a calibration amplitude and phase that, when applied to the filtered output, makes cross-polarization terms in the scattering matrix the same as each other; and apply the calibration amplitude and phase correct at least one value in the filtered output.

### BRIEF DESCRIPTION OF THE SEVERAL VIEWS OF THE DRAWINGS

FIG. 1 is a graph illustrating range ambiguities separated from the main lobe of an antenna pattern.

FIG. 2 is a graph illustrating range ambiguities overlapping the main lobe of an antenna pattern.

FIGS. 3A, 3B and 3C are timing diagrams illustrating operation of example embodiments of a single polarization (single-pol) SAR system, a dual polarization (dual-pol) SAR system and a quad-pol SAR system, respectively.

FIG. 4 is a block diagram illustrating elements of a sub-band quad-pol SAR system to control range ambiguities.

FIG. 5 is a timing diagram illustrating an example sequence of transmitted and receiving operations for a quad-pol SAR system.

FIG. 6 is a plot of a characteristic of an example filter for rejecting range ambiguities in a frequency sub-band.

FIG. 7 is a flow chart illustrating an example embodiment of a sub-band quad-pol SAR imaging mode.

FIG. 8 is a flow chart illustrating a method for adjusting a scattering matrix of a target in a quad-pol SAR image.

FIG. 9 is a flow chart illustrating a method for estimating of a Faraday rotation angle.

FIG. 10 is a block diagram illustrating a quad-pol SAR system.

### DETAILED DESCRIPTION

### Sub-Band Imaging Mode for Quad-Pol Sar

### Range Ambiguities

It is well known that SAR suffers from the problems of range and azimuth ambiguities. Though range ambiguity can be addressed by simply not transmitting a second pulse until all returns from a first pulse have died out, in spaceborne SAR the problem is complicated by the long range to the ground.

The SAR data is generally sampled in azimuth at a rate somewhat larger than the azimuth Doppler bandwidth. The azimuth Doppler bandwidth can be reduced by increasing the azimuth (or along track) dimension of the antenna. Decreasing the azimuth sampling rate, or pulse repetition frequency (PRF), increases the spacing between range ambiguities, and the range ambiguity level decreases as the range ambiguities move further away from the peak of the antenna pattern.

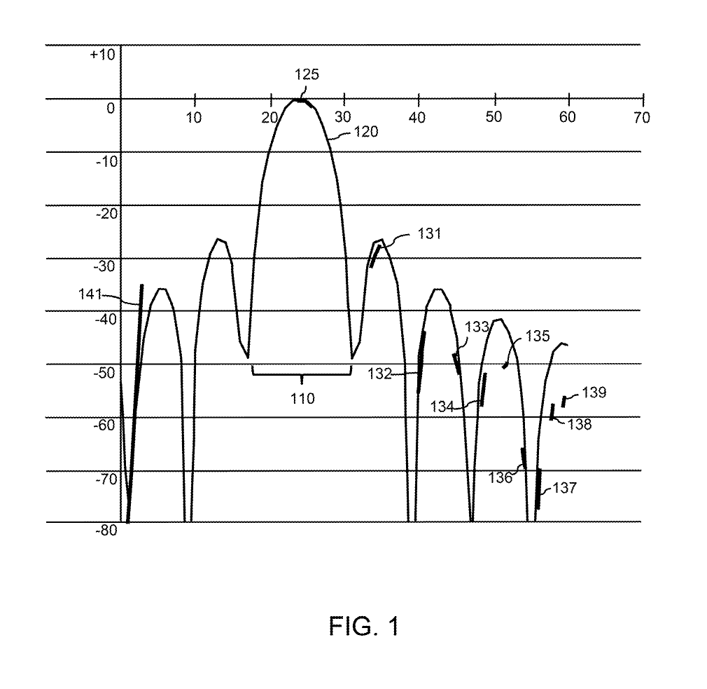

FIG. 1 is a graph illustrating range ambiguities separated from the main lobe 110 of an antenna pattern 120. The example shown in FIG. 1 is for an L-band radar system comprising an antenna array of physical dimensions 3 m by 1.8 m, operating at a pulse repetition frequency (PRF) of 3,600 Hz.

FIG. 1 shows the main beam 125 and two first range ambiguities 131 and 141 on either side of main lobe 110. First range ambiguities 131 and 141 are well separated from main lobe 110 and at levels of −25 dB or lower relative to the level of main lobe 110.

FIG. 1 also shows second, third, fourth, fifth, sixth, seventh, eighth, and ninth range ambiguities 132, 133, 134, 135, 136, 137, 138, and 139, respectively.

Increasing the PRF can cause the range ambiguities to move closer to the main lobe of the antenna (in elevation), and can result in increased degradation of the image.

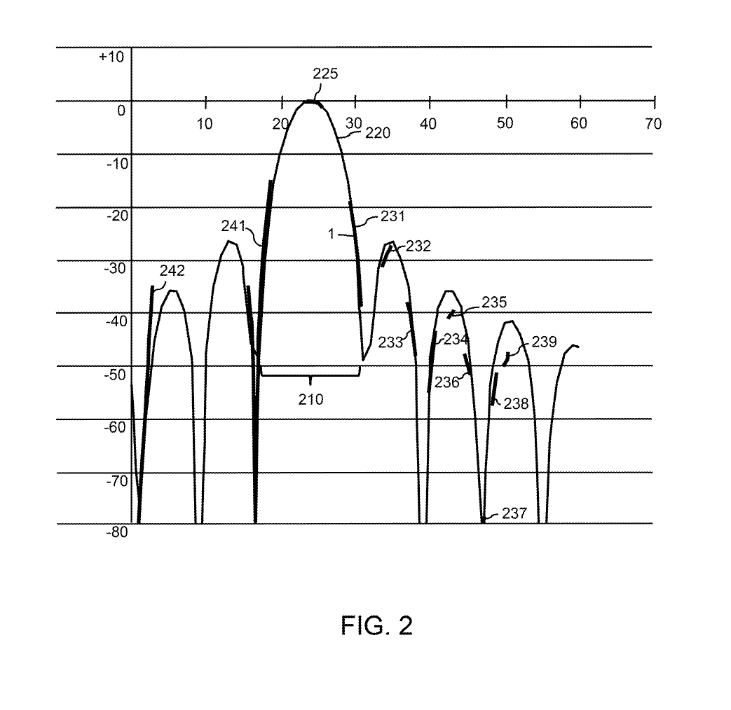

FIG. 2 is a graph illustrating range ambiguities overlapping the main lobe 210 of an antenna pattern 220. Like FIG. 1, the example shown in FIG. 2 is for an L-band radar system comprising an antenna array of physical dimensions 3 m by 1.8 m. In FIG. 2, the L-band radar system is operating at a pulse repetition frequency (PRF) of 7,200 Hz.

FIG. 2 shows main beam 225 and two first range ambiguities 231 and 241 on either side of main lobe 210. First range ambiguities 231 and 241 overlap main lobe 210 and at levels of −20 dB or higher relative to the level of main lobe 210.

No reduction of sidelobes through vertical weighting of the antenna will help to control range ambiguities 231 and 241.

FIG. 2 also shows second range ambiguities 232 and 242 on either side of the main lobe, as well as third, fourth, fifth, sixth, seventh, eighth, and ninth range ambiguities 233, 234, 235, 236, 237, 238, and 239, respectively.

One way to control range and azimuth ambiguities is to increase the size of the antenna array.

In practice, most spaceborne SAR antennas are very large, with a range of 9 m to 15 m being typical for the along track dimension of the antenna array. For example, spaceborne SAR Radarsat-2 has an antenna that is 15 m long, and ALOS-2 has an antenna of 9.9 m. TerraSAR-L has a SAR antenna of dimensions 11 m by 2.86 m, and a total launch mass of 2.8 tons.

Consequently, conventional spaceborne SAR antennas are typically some of the largest structures flown in space. They need complex deployment mechanisms, and even when the antenna is stowed for launch, the mass of the large antenna needs to be tied down and supported by a large spacecraft bus. Launching such spacecraft requires a launch vehicle with sufficiently large payload accommodation and lift capacity.

It has been proposed in the literature that a spaceborne SAR system with a smaller antenna can be practical, provided the following conditions can be met: i) the PRF is less than the azimuth Doppler bandwidth, ii) the processing bandwidth is reduced, and iii) the data window in range is chosen to be less than the available swath [see Freeman, A. et al. (2000) IEEE Trans. Geosci. and Remote Sensing, vol. 38].

Unfortunately, for a quad-pol SAR system, the PRF has to be doubled, and range ambiguities cannot be controlled by conventional means except by using a larger antenna.

### Range Ambiguities and Quad-Pol SAR

Conventional quad-pol SAR systems operate with interleaved transmission of alternate horizontal (H) and vertical (V) polarized pulses, receiving both H- and V-polarizations to build up a measurement of the full scattering matrix for each pixel on the ground [see, for example, Werninghaus, R. et al. (2004) Proceedings of EUSAR 2004, and Lombardo, P. et al. (2006) IEEE Proceedings on Radar, Sonar and Navigation, vol. 153, no. 2]

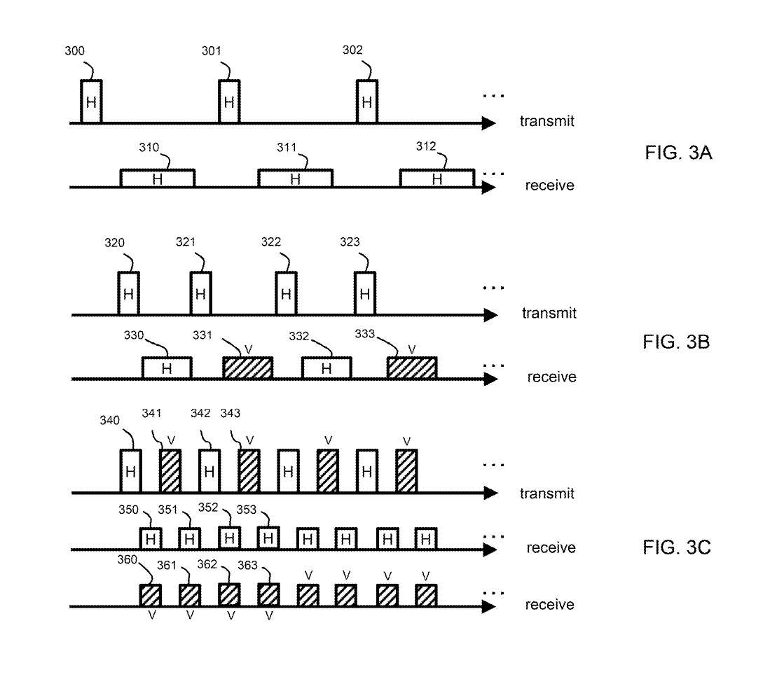

FIGS. 3A, 3B and 3C are timing diagrams illustrating operation of example embodiments of a single polarization (single-pol) SAR system, a dual polarization (dual-pol) SAR system and a quad-pol SAR system, respectively.

A single-pol SAR system by definition generates a single channel of data. Radar waves of one polarization are transmitted and radar waves of the same or a different polarization are received. FIG. 3A illustrates waveforms of a single-pol SAR system transmitting horizontally polarized waves and receiving the same. The resulting channel is known as HH. In FIG. 3A the single-pol SAR system transmits horizontally polarized pulses 300, 301, 302 and so on, and receives corresponding horizontally polarized backscattered returns 310, 311, 312 and so on.

In another implementation, a single-pol SAR system can transmit V and receive V, resulting in VV data. In yet another implementation, a single-pol SAR system can transmit H and receive V, resulting in a cross-polarization channel HV.

A dual-pol SAR system generates two channels of data. FIG. 3B shows the waveforms a dual-pol SAR system transmits, including H pulses 320, 321, 322, 323 and so on, and receives, including H returns 330, 332 and so on, and including V returns 331, 333 and so on. The resulting channels are known as HH and HV.

In another implementation, a dual-pol SAR system can generate VV and VH channels of data.

A quad-pol SAR system generates four channels of data. FIG. 3C shows waveforms a quad-pol SAR system transmits, including H pulses 340, 342 and so on, interleaved with V pulses 341, 343 and so on. For each transmitted pulse, the quad-pol SAR system receives both H returns 350, 351, 352, 353 and so on, and V returns 360, 361, 362, 363 and so on. The four channels of data are known as HH, VV, HV and VH.

In this application, by convention, the first symbol of the pair of symbols denotes the transmitted polarization and the second symbol denotes the received polarization. For example, the HV channel corresponds to horizontally polarized transmission and vertically polarized reception.

In a quad-pol SAR system, the SAR designer typically adopts a PRF that is twice the PRF used for conventional modes of operation, interleaving H and V transmit pulses, and receiving both H and V-polarized returns for each. A limitation to such systems has been the presence of strong like-polarized (HH or VV) range ambiguities arriving at the same time as cross-polarized (HV or VH) returns from the desired imaged swath. The presence of these ambiguities can severely restrict the range of incidence angles and swaths for quad-pol SAR systems.

The measured values of the scattering matrix in the presence of range ambiguities can be expressed as follows:

$$( \begin{matrix}{M}_{HH} & {M}_{VH} \\ {M}_{HV} & {M}_{VV}\end{matrix} ) ≅ ( \begin{matrix}{S}_{hh} & {S}_{vh} \\ {S}_{hv} & {S}_{vv}\end{matrix} ) + {\sum }_{i odd} {RAR}_{i} ( \begin{matrix}{\hat{S}}_{{vh}_{i}} & {\hat{S}}_{{hh}_{i}} \\ {\hat{S}}_{{vv}_{i}} & {\hat{S}}_{{hv}_{i}}\end{matrix} ) + {\sum }_{i even} {RAR}_{i} ( \begin{matrix}{\hat{S}}_{{hh}_{i}} & {\hat{S}}_{{vh}_{i}} \\ {\hat{S}}_{{hv}_{i}} & {\hat{S}}_{{vv}_{i}}\end{matrix} )$$

where the ambiguities have been divided into odd ambiguities and even ambiguities, and RAR is the range ambiguity ratio.

In the above equation, the first term on the right-hand side represents the desired scattering matrix from the imaged swath. The remaining two terms represent range ambiguities (the ̂ denotes range ambiguous returns), with odd values of i corresponding to the opposite transmit polarization, and even values of i corresponding to the same polarization on transmit. The columns of the scattering matrix in the odd-valued range ambiguities are swapped because they arise from alternately transmitted pulses of the opposite polarization.

A consequence of the second term in the above equation is that, because of the higher PRF introduced by interleaving transmit pulses, HV and VH returns are dominated by like-polarization ambiguities. The like-polarization ambiguities can be between 4 dB and 10 dB higher than the cross-polarization (cross-pol) ambiguities.

One significance of this result is that the cross-pol terms are the ones worst affected by ambiguities. Co-polarization (HH and VV) returns are less affected. Only the cross-pol terms feature in the odd-numbered ambiguities. Even-numbered ambiguities are the same as for the single-pol SAR case.

Another significance of this result is that the range ambiguity having the worst effect is the first ambiguity. In the second ambiguity, the returns are from the same polarization as the first, and the third ambiguity is of much less concern.

### Known Approaches for Controlling Range Ambiguities in a Quad-Pol SAR

As described above, one approach for controlling range ambiguities in a quad-pol SAR is to increase the size of the SAR antenna.

Another approach is to modulate the transmitted chirp, for example by alternating up chirps and down chirps, and by including zero or it phase modulation [see Kankaku, Y. et al. (2009) Progress In Electromagnetics Research Symposium Proceedings]. While range ambiguities can be improved by about 10 dB this way, the approach is unsuitable for distributed targets.

Yet another approach is a type of dual-pol SAR known as compact polarimetry which reduces the complexity, cost, mass, and data rate of the SAR while maintaining some of the capabilities of a quad-pol SAR [see, for example, Souissi, B. et al. (2012) Investigation of the capability of the compact polarimetry mode to reconstruct full polarimetry mode using RADARSAT2 data].

In compact polarimetry, the transmitter polarization is either circular or linear and orientated at 45°, and the receivers are horizontally and vertically polarized as usual. The data can be used to construct a pseudo-covariance matrix that is similar to the full polarimetric covariance matrix.

### Apparatus and Method for Controlling Range Ambiguities in a Quad-Pol SAR

The technology described in this section is an apparatus and method for controlling range ambiguities in a quad-pol SAR. A key aspect of the technology is the generation of transmitted pulses in more than one frequency sub-band within the bandwidth of the quad-pol SAR system.

Generally, the technology comprises the generation of transmitted pulses in two frequency sub-bands within the bandwidth of the quad-pol SAR system. The quad-pol SAR system comprises a controller able to switch alternately from a first frequency sub-band to a second frequency sub-band, from pulse to pulse.

The quad-pol SAR system further comprises a receiver able to switch alternately from the first sub-band to the second sub-band from pulse to pulse. While receiving radar returns in the first sub-band, the receiver rejects returns in the second sub-band, and vice versa.

The first and second sub-bands are generally arranged to be non-overlapping and adjacent in frequency. In some situations, the first and second sub-bands can be configured to partially overlap or to be separated in frequency.

In some situations (for example, for very small antennas), the quad-pol SAR system can be configured to transmit pulses in more than two frequency sub-bands. The controller switches transmissions between the more than two sub-bands in sequence (for example, 1,2,3 . . . 1,2,3 . . . and so on). Similarly, the receiver switches reception between the more than two sub-bands in sequence, processing returns in the transmitted sub-band and rejecting returns in the other two or more sub-bands by using a suitably configured filter.

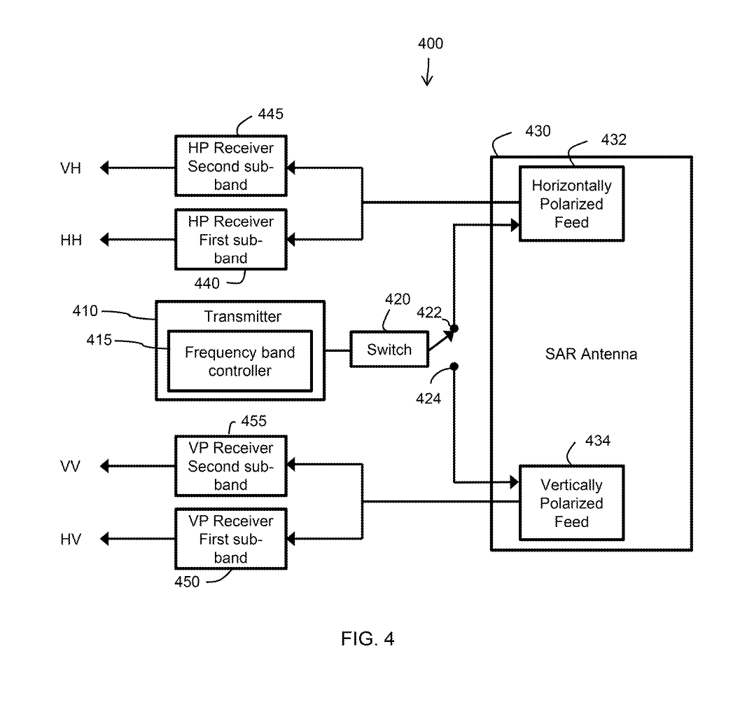

FIG. 4 is a block diagram illustrating elements of a sub-band quad-pol SAR system 400 that in operation controls range ambiguities.

Quad-pol SAR system 400 comprises a transmitter 410, a switch 420 and a SAR antenna 430. Transmitter 410 comprises frequency band controller 415. When switch 420 is in a first state (e.g., an upper position 422 in FIG. 4), transmitter 410 is routed to horizontally polarized antenna feed 432. When switch 420 is in a second state (e.g., a lower position 424 in FIG. 4), transmitter 410 is routed to vertically polarized antenna feed 434.

Frequency band controller 415 determines whether to transmit a pulse in the first sub-band or the second sub-band. For the quad-pol SAR system 400 illustrated in FIG. 4, when transmitter 410 transmits a horizontally polarized (HP) pulse, the pulse is transmitted in the first sub-band. When transmitter 410 transmits a vertically polarized (VP) pulse, the pulse is transmitted in the second sub-band.

A radar return received at horizontally polarized (HP) antenna feed 432 in the first sub-band is a HP return corresponding to a HP transmitted pulse. This return belongs to a HH channel 440.

A radar return received at horizontally polarized (HP) antenna feed 432 in the second sub-band is a HP return corresponding to a VP transmitted pulse. This return belongs to a VH channel 445.

A radar return received at vertically polarized (VP) antenna feed 434 in the first sub-band is a VP return corresponding to a HP transmitted pulse. This return belongs to a HV channel 450.

A radar return received at vertically polarized (VP) antenna feed 434 in the second sub-band is a VP return corresponding to a VP transmitted pulse. This return belongs to a VV channel 455.

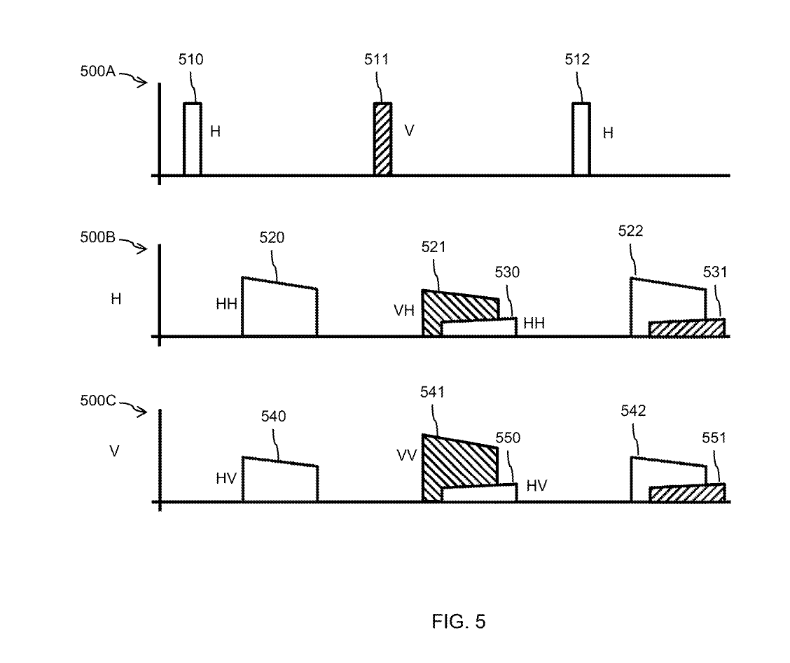

FIG. 5 is a timing diagram illustrating an example sequence of transmitted and receiving steps for a quad-pol SAR system.

FIG. 5 comprises three corresponding timelines 500A through 500C. Timeline 500A is the timeline for the transmission of pulses. Timeline 500B is the timeline for the reception of horizontally polarized returns. 500C is the timeline for the reception of vertically polarized returns.

In the example shown in FIG. 5, when the quad-pol SAR system transmits a horizontally polarized pulse, it is transmitted in the first sub-band. The first sub-band pulses and returns are indicated by shapes with no shading. The second sub-band pulses and returns are indicated by shapes with shading.

Referring to timeline 500A, quad-pol SAR system transmits a HP pulse 510 in the first sub-band, followed by a VP pulse 511 in the second sub-band, followed by another HP pulse 512 in the first sub-band and so on.

Referring to timelines 500B and 500C, HP pulse 510 generates HH and HV returns 520 and 540, respectively. VP pulse 511 generates VH and VV returns 521 and 541, respectively.

HP pulse 510 generates HH and HV first range ambiguities 530 and 550, respectively. VP pulse 511 generates VH and VV first range ambiguities 531 and 551, respectively.

Since first range ambiguities 530, 550, 531 and 551 are in different sub-bands than the corresponding returns 520, 540, 521 and 541, respectively, they can be rejected by a suitable filter.

The quality of the quad-pol SAR image can be improved by increasing the degree of rejection by the filter. The filter can be implemented in a receiver on-board a spacecraft or aircraft, or on the ground after the data has been downlinked for processing.

Any filter with suitable characteristics can be used, including an analog filter or a digital filter.

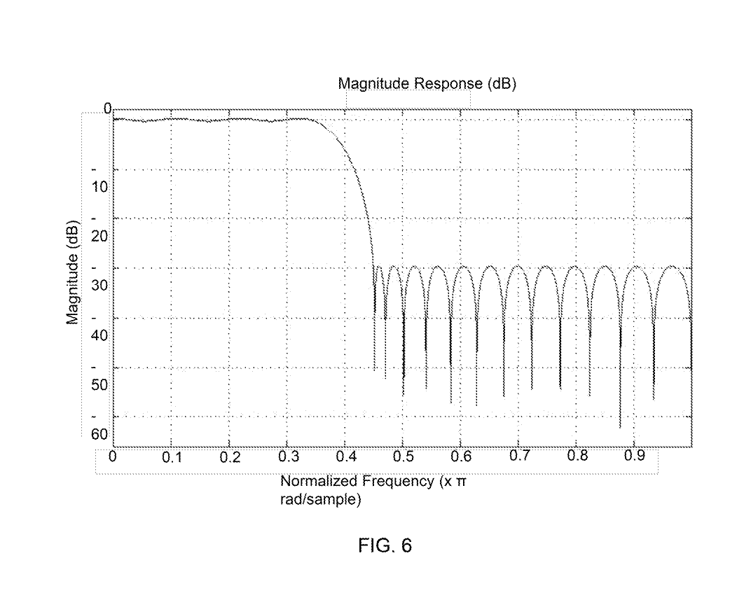

FIG. 6 is a plot of a characteristic of an example filter for rejecting range ambiguities in a frequency sub-band. In the example shown, a first sub-band can pass through the filter substantially unattenuated, while a second sub-band can be attenuated by approximately 30 dB for a suitable choice of frequency and bandwidth.

The first range ambiguities can be attenuated by a filter such as the filter of FIG. 6 prior to pulse compression. If both the radar return and the first range ambiguity are backscatter from distributed targets, and there is no processing gain in the pulse compression, then the odd range ambiguities can be attenuated by the filter out-of-band rejection.

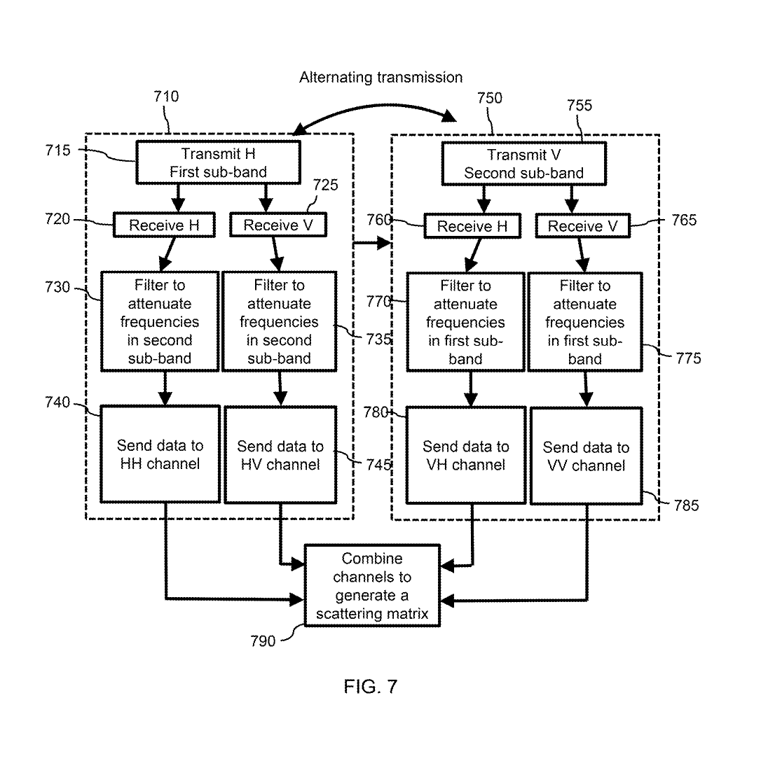

FIG. 7 is a flow chart illustrating an example embodiment of a sub-band quad-pol SAR imaging mode 700. Sub-band mode 700 comprises a first sequence of acts 710 (indicated by a dashed line) and a second sequence of acts 750. Sequences 710 and 750 alternate during transmission of a plurality of pulses.

The first sequence 710 comprises acts 715 through 745. At 715, the quad-pol SAR system transmits a H pulse on a first sub-band. At 720 and 725, the radar return corresponding to the H pulse is received in H and V, respectively.

At 730 and 735, the H and V polarizations of the radar return are filtered to attenuate frequencies in a second sub-band, respectively.

At 740, the filtered H return is sent to the HH channel. At 745, the filtered V return is sent to the HV channel.

The second sequence 750 comprises acts 755 through 785. At 755, the quad-pol SAR system transmits a V pulse on the second sub-band. At 760 and 765, the radar return corresponding to the V pulse is received in H and V, respectively.

At 770 and 775, the H and V polarizations of the radar return are filtered to attenuate frequencies in the first sub-band, respectively.

At 780, the filtered H return is sent to the VH channel. At 785, the filtered V return is sent to the VV channel.

At 790, the four channels (HH, HV, VH and VV) are combined to generate a scattering matrix.

Referring again to the equation describing the measured scattering matrix with odd and even range ambiguities:

$$( \begin{matrix}{M}_{HH} & {M}_{VH} \\ {M}_{HV} & {M}_{VV}\end{matrix} ) ≅ ( \begin{matrix}{S}_{hh} & {S}_{vh} \\ {S}_{hv} & {S}_{vv}\end{matrix} ) + {\sum }_{i odd} {RAR}_{i} ( \begin{matrix}{\hat{S}}_{{vh}_{i}} & {\hat{S}}_{{hh}_{i}} \\ {\hat{S}}_{{vv}_{i}} & {\hat{S}}_{{hv}_{i}}\end{matrix} ) + {\sum }_{i even} {RAR}_{i} ( \begin{matrix}{\hat{S}}_{{hh}_{i}} & {\hat{S}}_{{vh}_{i}} \\ {\hat{S}}_{{hv}_{i}} & {\hat{S}}_{{vv}_{i}}\end{matrix} )$$

For the purposes of the following description, assume that H is transmitted on the first sub-band, and on the next pulse V is transmitted on the second sub-band. The odd pulses are attenuated substantially by the first sub-band filter, with the result that the received signal in the first sub-band is:

$${( \begin{matrix}{M}_{HH} & 0 \\ {M}_{HV} & 0\end{matrix} )}_{First Sub \text{-} band} ≅ ( \begin{matrix}{S}_{hh} & 0 \\ {S}_{hv} & 0\end{matrix} ) + {\sum }_{i even} {RAR}_{i} ( \begin{matrix}{\hat{S}}_{{hh}_{i}} & 0 \\ {\hat{S}}_{{hv}_{i}} & 0\end{matrix} )$$

The odd ambiguities have been eliminated by filtering, and only the first column is kept:

$${( \begin{matrix}{M}_{HH} & 0 \\ {M}_{HV} & 0\end{matrix} )}_{First Sub \text{-} band}$$

The vertically polarized components in the second sub-band result in (after filtering out the odd ambiguities in the first sub-band):

$${( \begin{matrix}{M}_{HH} & {M}_{VH} \\ {M}_{HV} & {M}_{VV}\end{matrix} )}_{Second Sub \text{-} band} ≅ ( \begin{matrix}0 & {S}_{vh} \\ 0 & {S}_{vv}\end{matrix} ) + {\sum }_{i even} {RAR}_{i} ( \begin{matrix}0 & {\hat{S}}_{{vh}_{i}} \\ 0 & {\hat{S}}_{{vv}_{i}}\end{matrix} )$$

Similarly, the odd ambiguities have been eliminated, or at least reduced, in the vertical transmissions by filtering, and only the second column is now kept:

$${( \begin{matrix}0 & {M}_{VH} \\ 0 & {M}_{VV}\end{matrix} )}_{Second Sub \text{-} band}$$

The two columns can be combined to form the full quad-pol scattering matrix:

$$( \begin{matrix}{M}_{HH} & {M}_{VH} \\ {M}_{HV} & {M}_{VV}\end{matrix} )$$

The returns from the ground in the separate first and second sub-bands within the bandwidth of the SAR are statistically independent. In other words, the returns from the H Pulse (HH and HV)^{T} are statistically independent to the returns from the V Pulse (VH and VV)^{T}.

Completing sub-band mode 700 involves determining a relationship between the two independent sets of returns. The key to this is scattering reciprocity, as explained in the following section.

Correction for Scattering Reciprocity

The reciprocity theorem states that in the monostatic backscattering direction (typical for quad-pol SARs), the cross-polarization terms should, at least in principle, be the same.

Sₕᵥ=Sᵥₕ

where the scattering matrix is defined as

$$( \begin{matrix}{S}_{hh} & {S}_{vh} \\ {S}_{hv} & {S}_{vv}\end{matrix} )$$

and where the terms Sₘₙ denote the polarization (h or v) of the scattered and incident fields respectively.

This relationship holds true for trihedral corner reflectors and horizontal dihedral corner reflectors, for which:

Sₕᵥ=Sᵥₕ=0

Rotating the dihedral corner reflector by 45° yields:

Sₕᵥ=Sᵥₕ+1

Similarly, a vertical cylinder has a scattering matrix in which:

Sₕᵥ=Sᵥₕ=0

Rotating the vertical cylinder by 45° yields:

Sₕᵥ=Sᵥₕ=−1

Note that the cross-polarization term relationships are independent of frequency. The relationship between the cross-polarization terms can be used to calibrate a quad-pol SAR system, for example by using a trihedral corner reflector as a calibration target.

In practice, the phase of the product SₕᵥS*ᵥₕ can vary slightly from pixel to pixel owing to system noise. To get a good estimate of the phase relationship, the complex product can be averaged over an entire scene [see, for example, van Zyl J. & Kim Y. (2011) Synthetic Aperture Radar Polarimetry, Wiley].

In the technology described herein, the above relationship can be used to relate the HV term captured in one frequency sub-band with the VH term captured in the other frequency sub-band.

First, the system determines a calibration amplitude and phase required to make the cross-polarization terms in the scattering matrix the same as each other, or at least to reduce the difference between them when the calibration amplitude and phase is applied to the filtered output. Then the calibration amplitude and phase is applied to the VV term, with the result that the full scattering matrix is acquired, free of the odd range ambiguities.

The even ambiguities are controllable by other means not described here.

A benefit of combining the sub-band imaging mode disclosed above with the cross-pol calibration of the scattering matrix described in this section is that high-quality quad-pol SAR imaging can be performed with a SAR antenna approximately half the size of conventional technology.

### Co-Spatial and Co-Temporal Measurement of Faraday Rotation

### Faraday Rotation

When linearly polarized electromagnetic waves propagate through the ionosphere in the presence of the earth's magnetic field, they undergo a rotation of the plane of polarization. This magneto-optical phenomenon is known as Faraday rotation.

The Faraday rotation angle θ is proportional to the Total Electron Content (TEC) along the propagation path, and related to the magnitude and alignment of the magnetic field vector and the propagation vector.

Furthermore, the Faraday rotation angle is inversely proportional to the square of the frequency. For a spacecraft at 400 km altitude, the Faraday rotation angle can be negligible at C-Band (4-8 GHz), while it can be as much as 30° at L-Band (1-2 GHz) during solar maximum.

By modelling the effects of Faraday rotation on HH, HV, and VV backscatter, it has been shown that the recovery of geophysical parameters from these three measures are likely to be significantly affected for values of 0>5° [see Wright, P. et al. (2003) IEEE Trans. Geosci. and Remote Sensing, vol. 41].

It has been shown that Faraday rotation angles of less than 5° are generally acceptable for a number of commonly used parameter extraction methods from SAR. In practice, this means that for reliable classification of areas and objects in radar images, it is desirable that the Faraday rotation is corrected to within an accuracy of 5°.

For longer wavelength SAR systems at high altitudes (>200 km) (e.g., Seasat SAR, the Japanese Space Agency's JERS-1 and Phased Array L-Band SAR (PALSAR), the European TerraSAR system) Faraday rotation may cause significant measurement error. Depending on the local ionospheric conditions during data in-take, Faraday rotation may cause the greatest amount of uncertainty in backscatter measurements compared to any other error source [see Freeman, A. & Saatchi, S. (2004) IEEE Trans. Geosci. and Remote Sensing, vol. 42].

The earth's ionosphere is the region of the upper atmosphere with large quantities of ionized particles. In the presence of the earth's magnetic field, the electromagnetic wave propagation properties become anisotropic, and the ionosphere becomes birefringent with differing indexes of refraction for left and right circular polarizations, causing a rotation of the polarization vector.

The parameters of the ionosphere are dynamic, and their fluctuations depend on diurnal, seasonal, latitudinal, and solar cycle effects. This variation makes accurate co-spatial and co-temporal predictions of the Faraday rotation of the polarization vectors difficult.

Various techniques have been documented for prediction of Faraday Rotation [see Nicoll F. & Meyer J. (2008) IEEE Trans. Geosci. and Remote Sensing, vol. 46].

The magnitude of the Faraday rotation angle is inversely dependent on the square of the frequency, and also dependent on the direction of the earth's magnetic field and the local ionospheric ionized particle and electron density.

In the presence of the earth's magnetic field, the Faraday rotation angle θ resulting from one-way propagation through the ionosphere is given by the following equation:

$$θ = \frac{K}{{f}^{2}} \int NH cos ϕ sec χ \cdot dh [ rads ]$$

where
K 2.97×10⁻²;
f radio propagation frequency [hertz];
N electron concentration (per cubic meter);
H intensity of earth's magnetic field (amperes per meter);
φ angle between the normal to the direction of wave propagation and the magnetic field;
χ vertical angle of the ray;
sec χ dh differential element of the path length (dh).

The above equation shows that prediction of the Faraday rotation angle θ requires the value of the total electron current (TEC), the value of magnetic field B, and the angle between magnetic field B and the direction of wave propagation.

Table 1 (below) shows the estimated values of Faraday rotation angle for three different radar wavebands (C-Band, L-Band and P-Band) under peak TEC conditions. They correspond to expected values for a spaceborne SAR system in a low-earth polar orbit (<1200 km altitude), observing during the highest anticipated TEC value for a solar maximum. As such, these values provide an upper bound on the expected effects of Faraday rotation on linearly polarized backscatter signatures for each of the three wavebands. Typical observed values will generally be lower than the values in Table 1.

TABLE 1

| | θ (degrees) |
|---|---|
| C-Band (6 cm) | 2.5° |
| L-Band (24 cm) | 40° |
| P-Band (68 cm) | 321° |

The inverse dependence of the Faraday rotation angle on the square of the frequency is evident in Table 1 (above). Of the three wavebands, the effects of Faraday rotation are least significant at C-band, and become more significant at L-band and P-band.

### The Effect of Faraday Rotation on the Measurement of the Scattering Matrix

Since Faraday Rotation produces a rotation of a linearly polarized wave, it follows that Faraday rotation can impose a correlation between the co- and cross-pol elements of the scattering matrix. Even if the actual scattering matrix satisfies reciprocity, as is the usual case with natural targets, the measured scattering matrix will not necessarily either be symmetrical or satisfy reciprocity in the case when Faraday rotation is present [see van Zyl J. & Kim Y. (2011) Synthetic Aperture Radar Polarimetry, Wiley].

As described above, a sub-band approach to suppressing range ambiguities for quad-pol imaging depends on the reciprocity of the measured scattering matrix. It is therefore desirable that the data can be corrected such that the cross-pol terms M_{HV} and M_{VH} in the measured scattering matrix are approximately equal. Without this correction, the Faraday rotation can introduce an error into the sub-band quad-pol imaging.

Since, as described above, the Faraday rotation angle is inversely proportional to the square of the frequency, it is especially desirable to correct for Faraday rotation for sub-band quad-pol radar systems operating at a lower frequency such as L-Band.

The technology described herein comprises a method for Faraday rotation correction based on transmitting and receiving circularly polarized waves. The next section describes the effect of Faraday rotation on circularly polarized waves.

### Circular Polarization and Faraday Rotation

For the purposes of the showing how Faraday rotation affects circularly polarized electromagnetic waves, first consider a linearly polarized plane wave propagating through a lossless, semi-infinite medium in the direction of the earth's magnetic field of intensity H̅.

In a coordinate system comprising a rectangular set of axes x, y, and z with the z-axis parallel to H̅, the electric field vector of the plane wave lies in the x-y plane, orthogonal to both the direction of propagation of the wave and the earth's magnetic field vector H̅.

For a monochromatic wave, the magnitude of the electric field vector varies as follows:

|Ē|=E₀ cos(ωt−β₀z)

where ω is the angular frequency and β₀ is the phase constant for the rotating linearly polarized wave.

Expressing the electric field vector in terms of the linear basis vectors iₓ and i_{y}, along the x and y axes:

Ē=[E₀ₓiₓ+E_{0y}i_{y}]cos(ωt−β₀z)

Ē=|Ē|cos(θiₓ)+|Ē|sin(θi_{y})

Ē=Re(|Ē|e^{jθ})iₓ+Im(|E|e^{jθ})ⁱ^{_{y}}

The equation above expresses the x and y-components of electric field vector Ē in terms of the real and imaginary parts of the vector:

|Ē|e^{jθ}=E₀e^{jθ}cos(ωt−β₀z)

In this system of notation, the term e^{jθ} indicates spatial orientation. Thus, a right-hand circularly polarized wave is represented by Ee^{jωt}, and a left-hand circularly polarized wave is represented by Ee^{-jωt}, where E may be complex.

Since the Faraday rotation angle is proportional to the length of the medium of propagation, the angle can be expressed as θ=az, where a is the Faraday rotation per unit length, θ is the angle of rotation of the plane of polarization at z assuming the wave enters the medium aligned with the x-axis at z=0.

Then the expression for |E|e^{jθ} is:

$$\begin{matrix}{E}_{0} {e}^{j θ} cos ( ω t - {β}_{0} z ) = \frac{{E}_{0}}{2} {e}^{jaz} [ {e}^{j ( ω t - {β}_{0} z )} + {e}^{- j ( ω t - {β}_{0} z )} ] \\ = \frac{{E}_{0}}{2} [ {e}^{j [ ω t - ( {β}_{0} - a ) z ]} + {e}^{- j [ ω t - ( {β}_{0} + a ) z ]} ]\end{matrix}$$

The rotating linearly polarized wave can therefore be expressed as the sum of two counter-rotating circularly polarized plane waves traveling along the z-axis, with different phase velocities:

$$\vert \overline{E} \vert {e}^{j θ} = \frac{{E}_{0}}{2} [ {e}^{j [ ω t - {β}_{+} z ]} + {e}^{- j [ ω t - {β}_{-} z ]} ]$$

where (β₀−a)=β₊ and (β₀+a)=β₋.

This result forms a basis for the technology described herein for co-spatial and co-temporal measurement and correction of the Faraday rotation.

One of the circularly polarized plane waves is circularly polarized in the same sense as the angle of rotation of the linearly polarized wave and has a phase constant β₊=β₀−a, while the other is circularly polarized in the opposite sense having β₋=β₀+a.

The Faraday rotation angle can be expressed as:

$$θ = \frac{{β}_{-} - {β}_{+}}{2} z$$

The Faraday rotation angle can therefore be estimated from measurements of phase constants β₊ and β₋.

While β₀, the phase constant for the rotating linearly polarized wave in the medium, is not necessarily identical to the phase constant of a non-rotating, linearly polarized wave traveling through the medium, the method described herein to estimate the Faraday rotation works because it depends mainly on the different phase velocities of the two counter-rotating circularly polarized plane waves traveling along the z-axis.

### Method for Faraday Rotation Measurement and Correction

### Using an Alternating Circularly Polarized SAR

A method for the co-spatial and co-temporal measurement and correction of the Faraday rotation using an alternating circularly polarized SAR is described herein.

The method is based on the result from the previous section that a rotating linearly polarized wave can be expressed as the sum of two counter-rotating circularly polarized plane waves with different phase velocities.

The co-spatial and co-temporal measurement is made at substantially the same place and at substantially the same time as the quad-pol SAR images requiring Faraday rotation correction are acquired. In other words, the method measures the Faraday rotation angle for propagation along substantially the same path as the path used when acquiring the quad-pol SAR images.

The Faraday rotation angle generally varies from one propagation path to another, and at different times along the same propagation path. The technology described in this application provides an estimate of the Faraday rotation angle along the propagation path used when acquiring the quad-pol images at the time the images were acquired. The estimate can be based, at least in part, on measurements made during time periods adjacent to the image acquisition time, for example immediately prior to image acquisition and immediately following image acquisition. The estimate can be based, at least in part, on an average of measurements made immediately prior to, and immediately following, image acquisition.

The alternating circularly polarized SAR system is configured via hardware and/or software to transmit pulses of polarized electromagnetic waves of alternating handedness, for example a first right-hand circular polarization (RHCP) pulse, followed by a first left-hand circular polarization (LHCP) pulse, followed by a second RHCP and a second LHCP pulse, and so on. In this manner, the LHCP pulses are interleaved with the RHCP pulses, and vice versa.

In general, a RHCP transmitted pulse results in backscatter that is substantially left-hand circularly polarized, and vice versa. This is because odd-bounce reflections usually dominate, as from specular facets, Bragg scattering from random rough distributions, or trihedrals (three sided corners, either natural or fabricated) [see, for example, Raney R. K (2007) IEEE Trans. Geosci. and Remote Sensing, vol. 45].

The method described herein takes advantage of this fact to measure Faraday rotation by configuring the quad-pol SAR system to receive LHCP backscatter when a RHCP pulse is transmitted, and RHCP backscatter when a LHCP pulse is transmitted. In other words, in use the quad-pol SAR system combines the received horizontal and vertical linear polarizations such that the SAR system is alternately sensitive first to LHCP and then to RHCP, from one received pulse to the next, when the first transmitted pulse is RHCP. Similarly, if the first transmitted pulse is LHCP, the SAR system is configured to be alternately sensitive first to RHCP and then to LHCP.

A first image is formed from the transmitted RHCP pulses and the received LHCP backscatter.

A second image is formed from the transmitted LHCP pulses and the received RHCP backscatter.

Since the measured scattering matrix for the first and second images should be essentially the same, it follows that a difference between the first and second images, particularly in phase, results from the different phase constants β₊ and β₋ of the two counter-rotating circularly polarized plane waves.

In other words, the different phase constants β₊ and β₋ of the two counter-rotating circularly polarized plane waves caused by Faraday rotation lead to a measurable phase difference between the first and second images.

The measured phase difference between the first and second images corresponds to the temporal phase difference between the two counter-rotating circularly polarized plane waves, and provides an estimate of the Faraday rotation angle along the propagation path.

The phase of the first image caused by the phase constant β₋ is:

$${θ}_{-} = \frac{{β}_{-}}{2} z$$

where z is the two-way path length.

The phase of the second image cause by the phase constant β₋ is:

$${θ}_{+} = \frac{{β}_{+}}{2} z$$

The phase difference between the first and second images is an estimate of the Faraday rotation value:

$$θ = \frac{{β}_{-} - {β}_{+}}{2} z$$

The method comprises, firstly, capturing an alternating circularly polarized SAR image with a burst of pulses immediately prior to the acquisition of a quad-pol SAR image. The method further comprises, secondly, acquiring the quad-pol SAR image. The method may optionally comprise, thirdly, capturing a second alternating circularly polarized SAR image with a burst of pulses immediately after acquisition of the quad-pol SAR image, which may be desirable to improve the estimation accuracy of the co-spatial, co-temporal measurement of the Faraday rotation and correction thereof in the quad-pol SAR image.

Alternatively, the capturing an alternating circularly polarized SAR image with a burst of pulses may occur only after the acquiring of the quad-pol SAR image. In other words, an alternating circularly polarized SAR image as described above is captured immediately before the acquisition of the quad-pol SAR image or immediately after acquisition of the quad-pol SAR image, or both before and after acquisition of the quad-pol SAR image.

By the terms “immediately before” and “immediately after”, it is intended to indicate that the data are captured sufficiently close to the acquisition of the particular or corresponding quad-pol SAR image that the Faraday rotation correction can achieve the desired accuracy for classifying areas and targets in the quad-pol SAR image.

To implement the method described above, the quad-pol SAR system is configured to switch at a sufficient rate between different imaging modes, each mode transmitting and receiving different bursts of data. Specifically, the quad-pol SAR system switches at a sufficient rate between a burst of pulses with alternating RHCP and LHCP for measurement of the Faraday rotation, followed immediately or shortly thereafter by a burst of pulses for quad-pol imaging, and followed (optionally) immediately or shortly thereafter by another burst of pulses with alternating RHCP and LHCP for measurement of the Faraday rotation.

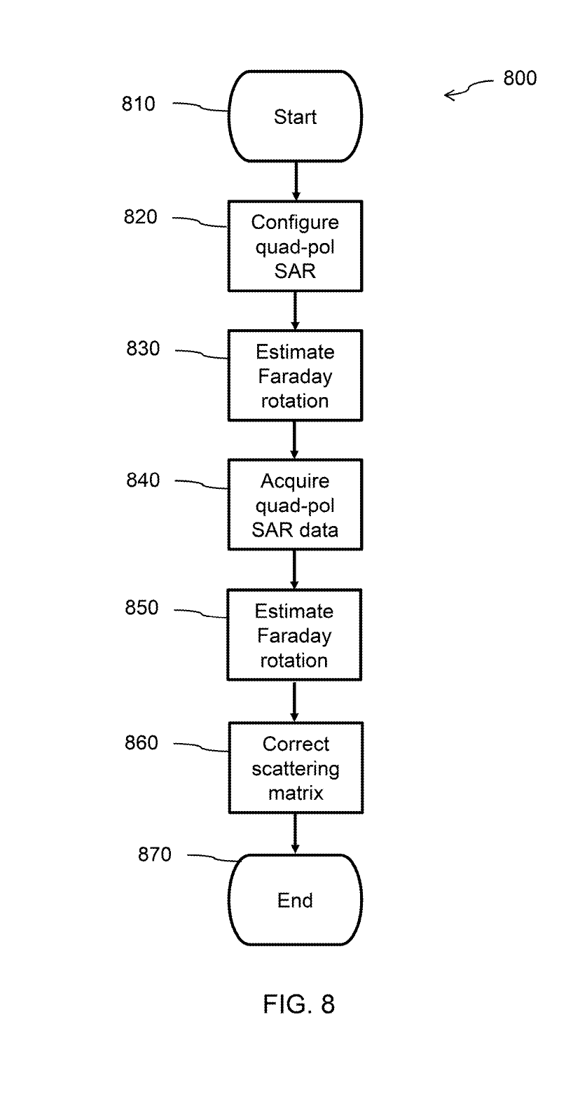

FIG. 8 is a flow chart illustrating a method 800 for adjusting a scattering matrix of a target in a quad-pol SAR image. Method 800 comprises acts 810 through 870. Method 800 starts at 810 and proceeds directly to 820.

At 820, the quad-pol SAR system is configured to operate in a first imaging mode and a second imaging mode, and to switch between the first and second imaging modes. In the first imaging mode, the quad-pol SAR system transmits a burst of pulses with alternating (or interleaved) RHCP and LHCP for measurement of the Faraday rotation. In the second imaging mode, the quad-pol SAR system acquires quad-pol SAR image data.

At 830, the quad-pol SAR system enters the first imaging mode, and collects and processes the data required to estimate the Faraday rotation along the two-way propagation path of the radar waves.

At 840, the quad-pol SAR system switches to the second imaging mode and acquires the quad-pol SAR imaging data.

At 850, the quad-pol SAR system switches back to the first imaging mode and generates another estimate of the Faraday rotation.

At 860, the quad-pol SAR system or some other component (e.g., Earth-based component) calculates an average of the estimates of the Faraday rotation and applies a correction to the scattering matrix. Method 800 ends at 870. Alternatively, the method 800 may repeat for additional acquisitions.

In some embodiments, either act 830 or 850 is omitted, and a single co-spatial, co-temporal estimate of the Faraday rotation is used to correct the scattering matrix.

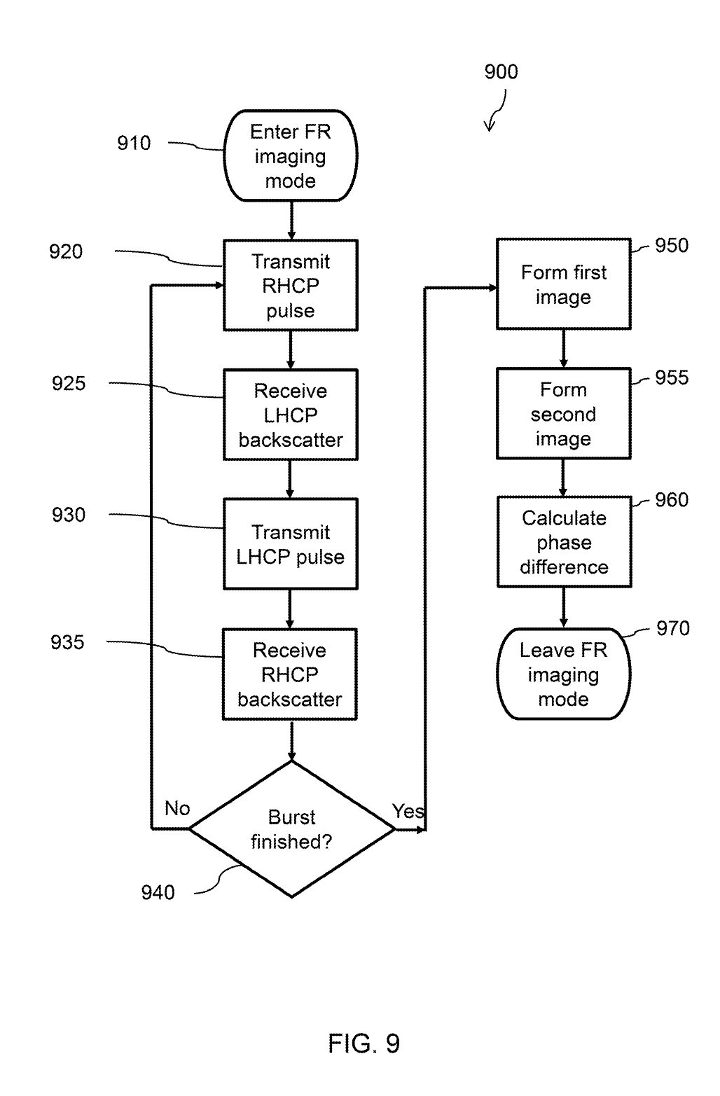

FIG. 9 is a flow chart illustrating a method 900 for estimating of a Faraday rotation angle. Method 900 comprises acts 910 through 970. Method starts at 910 entering the Faraday rotation imaging mode—the mode in which the quad-pol SAR system determines the Faraday rotation along the propagation path of the radar beam.

As described above, method 900 comprises interleaving RHCP and LHCP pulses in a burst of pulses, and receiving LHCP and RHP backscatter respectively. At 920, the quad-pol SAR transmits a RHCP pulse. At 925, the quad-pol SAR receives LHCP backscatter from the RHCP pulse. At 935, the quad-pol SAR transmits a LHCP pulse. At 935, the quad-pol SAR receives RHCP backscatter from the LHCP pulse. At 940, when the burst of pulses is finished, method 900 proceeds to 950.

At 950, the quad-pol SAR system or some other component forms a first image from the transmitted RHCP pulses and the received LHCP backscatter. At 955, the quad-pol SAR system or some other component forms a second image from the LHCP pulses and the RHCP backscatter.

At 960, the quad-pol SAR system or some other component estimates the Faraday rotation by calculating a phase difference between the first and second images, after which method 900 leaves the Faraday rotation imaging mode at 970.

Co-spatial, co-temporal determination and correction of Faraday rotation can be applied to any suitable fully or partially polarimetric SAR. For example, in compact polarimetry, as mentioned above, the transmitter polarization is either circular or linear and orientated at 45°, and the receivers are horizontally and vertically polarized as usual. A polarimetric SAR operating in a compact polarimetry mode can be configured to transmit alternating RHCP and LHCP pulses, and to receive horizontally and vertically polarized returns. The data acquired in this mode can be used to generate compact polarimetric SAR images and to determine and correct for Faraday rotation.

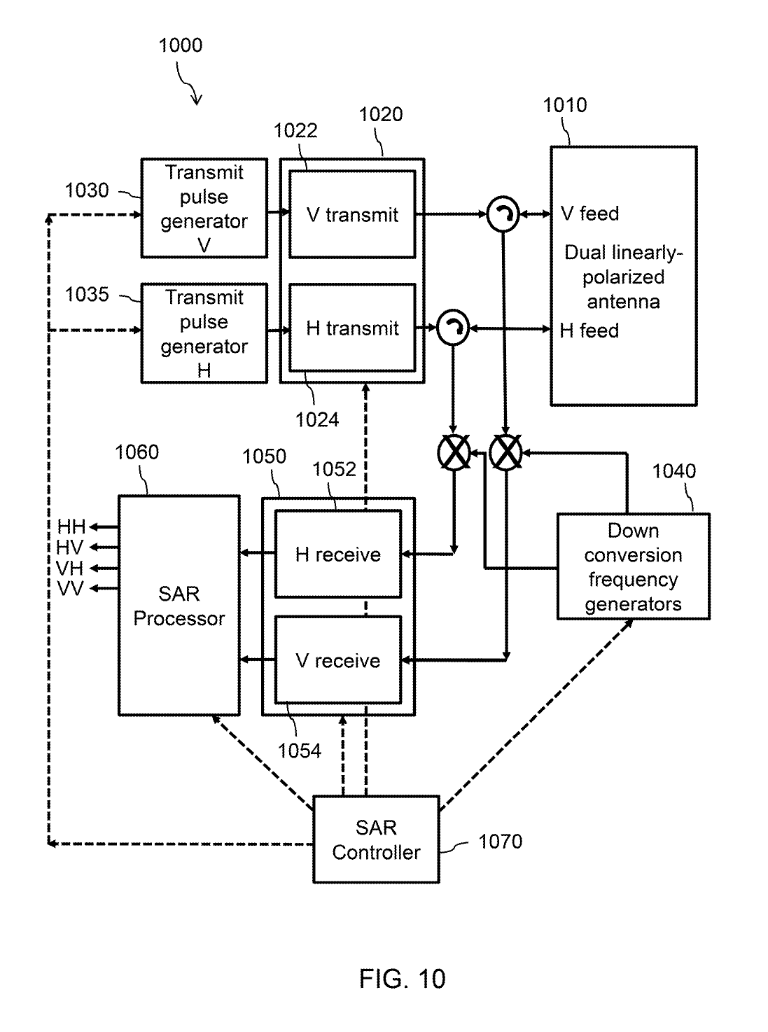

FIG. 10 is a block diagram illustrating a quad-pol SAR system 1000.

Quad-pol SAR system 1000 comprises a dual linearly-polarized antenna 1010, a transmitter 1020 and transmit pulse generators 1030 and 1035 for V and H pulses, respectively. Transmitter 1020 comprises V transmit component 1022 and H transmit component 1024.

Quad-pol SAR system 1000 further comprises down conversion frequency generators 1040, a receiver 1050, a SAR processor 1060 and a SAR controller 1070. Receiver 1050 comprises H receive component 1052 and V receive component 1054. SAR processor 1060 generates an output of four channels—HH, HV, VH and VV. SAR controller 1070 is connected to transmit pulse generators 1030 and 1035, transmitter 1020, down conversion frequency generators 1040, receiver 1050 and SAR processor 1060, and is configured to provide timing and control commands (as indicated by dotted lines in FIG. 10).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet and the teachings of U.S. provisional patent application Ser. No. 62/035,279, filed Aug. 8, 2014 are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation in a quad-pol synthetic aperture radar (SAR) system, the method comprising acquiring a set of quad-pol SAR data, the acquiring of the set of quad-pol SAR data comprising:
for each of a number of iterations i, from 1 to a number N where N is an integer greater than zero,
transmitting a first pulse with a first linear polarization in a first sub-band of a bandwidth;
receiving a first return from the first pulse in the first linear polarization;
providing the received first return in the first linear polarization to at least one filter as a first channel;
receiving the first return from the first pulse in a second linear polarization, the second linear polarization orthogonal to the first linear polarization;
providing the received first return in the second linear polarization to at least one filter as a second channel;
transmitting a second pulse with the second linear polarization in a second sub-band of the bandwidth;
receiving a second return from the second pulse in the first linear polarization;
providing the received second return in the first linear polarization to at least one filter as a third channel;
receiving the second return in the second linear polarization; and
providing the received second return in the second linear polarization to at least one filter as a fourth channel.

2. The method of claim 1, further comprising:
filtering the first and the second channels to attenuate frequencies in the second sub-band; and
filtering the third and the fourth channels to attenuate frequencies in the first sub-band.

3. The method of claim 1 wherein transmitting a first pulse with a first linear polarization in a first sub-band of a bandwidth includes transmitting the first pulse with one of a horizontal polarization and a vertical polarization.

4. The method of claim 1 wherein transmitting a second pulse with the second linear polarization in a second sub-band of a bandwidth includes transmitting a second pulse with the second linear polarization in a second sub-band that does not overlap the first sub-band.

5. The method of claim 1 wherein transmitting a first pulse with a first linear polarization in a first sub-band of a bandwidth includes transmitting the first pulse via a first antenna feed, and transmitting a second pulse with the second linear polarization in a second sub-band of the bandwidth includes transmitting the second pulse via a second antenna feed, the method further comprising:
operating at least one switch to successively couple a transmitter to the first antenna feed to transmit the first pulse with the first linear polarization in the first sub-band and to the second antenna feed to transmit the second pulse with the second linear polarization in the second sub-band.

6-7. (canceled)

8. The method of claim 1, further comprising:
generating a scattering matrix from the filtered output of the first, the second, the third and the fourth channels;
determining a calibration amplitude and phase that reduces the difference between cross-polarization terms in the scattering matrix; and
applying the calibration amplitude and phase to correct at least one value in the filtered output of at least one of the first, the second, the third and the fourth channels.

9. (canceled)

10. The method of claim 8, wherein determining a calibration amplitude and phase that reduces the difference between cross-polarization terms in the scattering matrix includes making cross-polarization terms in the scattering matrix the same as each other.

11. The method of claim 1, further comprising:
transmitting a third pulse with a polarization selected from one of the first or the second linear polarizations in a third sub-band of the bandwidth;
receiving a third return from the third pulse in a polarization selected from one of the first or the second linear polarizations; and
providing the received third return to at least one filter as a further channel.

12. The method of claim 1 wherein N is greater than 1.

13. A quad-pol synthetic aperture radar (SAR) system, comprising:
a dual linearly-polarized antenna comprising two orthogonal linear feeds;
at least one transmitter operatively connected to the antenna, wherein a bandwidth of the at least one transmitter comprises a first sub-band and a second sub-band;
a controller operatively coupled to the at least one transmitter and which in use causes the at least one transmitter to transmit a plurality of pulses, the plurality of pulses alternatingly having a first linear polarization in the first sub-band, and a second linear polarization in the second sub-band, wherein the second linear polarization is orthogonal to the first linear polarization; and
a receiver communicatively coupled to the antenna to receive two orthogonal linear polarizations of a set of radar returns from each of the plurality of pulses, and to provide received radar returns to at least one filter as a first, a second, a third and a fourth channel.

14. The quad-pol SAR system of claim 13, further comprising:
a signal processor comprising:
a first filter communicatively coupled to the receiver and which in use attenuates frequencies of the received radar returns in the second sub-band;
a second filter communicatively coupled to the receiver and which in use attenuates frequencies of the received radar returns in the first sub-band; and
a processor communicatively coupled to receive an output of the first and the second filters, and which in use generates a scattering matrix.

15. The quad-pol SAR system of claim 13 wherein the first filter filters the first and the second channels to attenuate frequencies in the second sub-band and the second filter filters the third and the fourth channels to attenuate frequencies in the first sub-band.

16. The quad-pol SAR system of claim 14 wherein the signal processor is co-located with the at least one transmitter, the controller, and the receiver on-board a spacecraft.

17. The quad-pol SAR system of claim 13 wherein the second sub-band does not overlap the first sub-band.

18. The quad-pol SAR system of claim 13, further comprising:
at least one switch which in use successively causes the dual linearly-polarized antenna to alternatingly transmit the pulses with the first linear polarization in the first sub-band and to transmit pulses with the second linear polarization in the second sub-band.

19-29. (canceled)

30. The system of claim 44 wherein to estimate the Faraday rotation angle, the at least one processor:
forms a first image from a plurality of transmitted right-hand circular polarization (RHCP) pulses and received left-hand circular polarization LHCP backscatter;
forms a second image from a plurality of transmitted LHCP pulses and received RHCP backscatter; and
determines a phase difference between the first image and the second image, wherein the phase difference is the estimate of the Faraday rotation angle.

31. The system of claim 30 wherein the at least one processor further:
causes at least one transmitter to transmit a plurality of RHCP pulses;
receives the LHCP backscatter from the plurality of RHCP pulses via a receiver;
causes the at least one transmitter to transmit a plurality of LHCP pulses interleaved with the plurality of RHCP pulses; and
receives the RHCP backscatter from the plurality of LHCP pulses via the receiver.

32. The system of claim 44 wherein the at least one processor estimates the Faraday rotation angle at a time which is one of before the set of quad-pol SAR data is acquired or after the set of quad-pol SAR data is acquired.

33. (canceled)

34. The system of claim 44 wherein the at least one processor estimates the Faraday rotation angle at a first time before the set of quad-pol SAR data is acquired to provide a first estimate of the Faraday rotation angle, and the at least one processor estimates the Faraday rotation angle at a second time after the set of quad-pol SAR data is acquired to provide a second estimate of the Faraday rotation angle, and the at least one processor further averages the first estimate and the second estimate to determine the Faraday rotation angle.

35. The system of claim 44 wherein the at least one processor is located on-board a spacecraft.

36-39. (canceled)

40. The method of claim 1, further comprising:
generating a scattering matrix from the filtered output of the first, the second, the third and the fourth channels;
estimating a Faraday rotation angle associated with the set of quad-pol SAR data; and
correcting the scattering matrix based on the estimated Faraday rotation angle, wherein the estimating of the Faraday rotation angle is performed co-spatially and co-temporally with the acquiring of the set of quad-pol SAR data.

41. The method of claim 40 wherein the estimating a Faraday rotation angle comprises:
transmitting a plurality of right-hand circular polarization (RHCP) pulses;
receiving left-hand circular polarization (LHCP) backscatter from the plurality of RHCP pulses;
forming a first image from the plurality of transmitted RHCP pulses and the received LHCP backscatter;
transmitting a plurality of LHCP pulses interleaved with the plurality of RHCP pulses;
receiving RHCP backscatter from the plurality of LHCP pulses;
forming a second image from the plurality of transmitted LHCP pulses and the received RHCP backscatter; and
determining a phase difference between the first image and the second image, wherein the phase difference is the estimate of the Faraday rotation angle.

42. The method of claim 40 wherein the estimating a Faraday rotation angle is performed at time which is one of before the acquiring of the set of quad-pol SAR data or after the acquiring of the set of quad-pol SAR data.

43. The method of claim 40 wherein estimating a Faraday rotation angle is performed at a first time before the acquiring of the set of quad-pol SAR data to provide a first estimate of the Faraday rotation angle, and performed at a second time after the acquiring of the set of quad-pol SAR data to provide a second estimate of the Faraday rotation angle, the method further comprising averaging the first estimate and the second estimate to determine the Faraday rotation angle.

44. The quad-pol SAR system of claim 13, further comprising:
at least one processor; and
at least one processor-readable medium that stores at least one of processor-executable instructions and data, wherein in use the at least one processor:
estimates a Faraday rotation angle associated with an acquired set of quad-pol SAR data co-spatially and co-temporally with the acquisition of the set of quad-pol SAR data, the set of quad-pol data representative of a target; and
corrects a scattering matrix of the target based on the estimated Faraday rotation angle.

45. A method of operation in a quad-pol synthetic aperture radar (SAR) imaging system which includes at least one processor and at least one processor-readable medium that stores at least one of processor-executable instructions and data, the method comprising:
acquiring a set of quad-pol SAR data representative of a target;
estimating a Faraday rotation angle associated with the acquired set of quad-pol SAR data; and
correcting a scattering matrix of the target based on the estimated Faraday rotation angle,
wherein the estimating of the Faraday rotation angle is performed co-spatially and co-temporally with the acquisition of the set of quad-pol SAR data.
